(19) United States
(12) Patent Application Publication
(10) Pub. No.: US 2024/0129741 A1
(43) Pub. Date: Apr. 18, 2024

(54) INFORMATION SECURITY EARLY WARNING DEVICE AND METHOD THEREOF

(71) Applicant: INSTITUTE FOR INFORMATION INDUSTRY, TAIPEI (TW)

(72) Inventors: Yu Chi TUNG, TAIPEI (TW); Ping-Chun CHEN, TAIPEI (TW)

(21) Appl. No.: 18/056,723

(22) Filed: Nov. 18, 2022

(30) Foreign Application Priority Data
Oct. 18, 2022 (TW) 111139523

(51) Int. Cl. H04W 12/122; H04L 9/40; H04W 12/73

(52) U.S. Cl. CPC H04W 12/122; H04L 63/0236; H04W 12/73

(57) ABSTRACT

An information security early warning device is provided, which includes a data capturing circuit, a memory and a processor. The processor is used for running a virtual user equipment, a virtual base station and a virtual core network, and performing the following operations: when the first data flow is detected as non-malicious and abnormal, simulating transmission of the first data flow from the virtual base station to the virtual core network, and determining whether a connection can be established; when the connection can be established, updating a setting of the anomaly detection by using the first data flow; when the connection cannot be established, selecting an error log including a first malicious procedure code from multiple detection logs generated by the virtual core network; and updating the malicious feature database by using the first malicious procedure code and the first data flow.

### CROSS-REFERENCE TO RELATED APPLICATION

This application claims priority to Taiwan Application Serial Number 111139523, filed Oct. 18, 2022, which is herein incorporated by reference in its entirety.

### BACKGROUND

### Field of Disclosure

The present disclosure relates to a communication technology. More particularly, the present disclosure relates to an information security early warning device and method thereof.

### Description of Related Art

In the fifth generation standalone (5G SA) architecture, since the software trend of fifth generation base stations, in addition to attacks that may be received from the outside, and the attacks are also possible between the access and mobility management function (AMF) and the next generation node B (gNB). Base station components developed on the basis of open source code can also be hacked into a springboard for attacking the fifth generation core network (5GC) (especially through the N2 interface).

### SUMMARY

The disclosure provides an information security early warning device, which includes a data capturing circuit, a memory and a processor. The data capturing circuit is configured for capturing a first data flow by mirroring. The memory is configured for storing a malicious feature database and a plurality of instructions. The processor is connected to the data capturing circuit and the memory, configured for running a virtual user equipment, a virtual base station and a virtual core network, and accessing the plurality of instructions to perform the following operations: detecting the first data flow according to the malicious feature database, and when the first data flow is not a malicious flow, performing an anomaly detection on the first data flow; when the first data flow is detected as abnormal, simulating transmission of the first data flow from the virtual base station to the virtual core network, and determining whether a connection between the virtual user equipment and the virtual core network can be established after the virtual core network receives the first data flow; when the connection between the virtual user equipment and the virtual core network can be established, updating a setting of the anomaly detection by using the first data flow; when the connection between the virtual user equipment and the virtual core network cannot be established, selecting an error log from a plurality of detection logs generated by the virtual core network, wherein the error log indicates that a first error packet in the first data flow has a first malicious procedure code; and updating the malicious feature database by using the first malicious procedure code and the first data flow.

The disclosure provides An information security early warning method, including: capturing a first data flow by mirroring; detecting the first data flow according to a malicious feature database, and when the first data flow is not a malicious flow, performing an anomaly detection on the first data flow; when the first data flow is detected as abnormal, simulating transmission of the first data flow from the virtual base station to the virtual core network, and determining whether a connection between the virtual user equipment and the virtual core network can be established after the virtual core network receives the first data flow; when the connection between the virtual user equipment and the virtual core network can be established, updating a setting of the anomaly detection by using the first data flow; when the connection between the virtual user equipment and the virtual core network cannot be established, selecting an error log from a plurality of detection logs generated by the virtual core network, wherein the error log indicates that a first error packet in the first data flow has a first malicious procedure code; and updating the malicious feature database by using the first malicious procedure code and the first data flow.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of the information security early warning device of the present disclosure.

FIG. 2 is a schematic diagram of implementing an information security early warning method according to some embodiments of the present disclosure.

FIG. 3 is a flowchart of detailed steps of one of the steps in FIG. 2 according to some embodiments of the present disclosure.

FIG. 4 is a schematic diagram of a simulating transmission according to some embodiments of the present disclosure.

FIG. 5 is a schematic diagram of establishing a connection according to some embodiments of the present disclosure.

FIG. 6 is a schematic diagram of detection logs according to some embodiments of the present disclosure.

FIG. 7 is a flowchart of steps further included in FIG. 2 according to some embodiments of the present disclosure.

FIG. 8 is a flowchart of steps further included in FIG. 2 according to some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

In a recent fifth generation mobile networks (5G) technology, a N2 interface between a radio access network (RAN), and a fifth generation core network (5GC) has no perfect warning and protection of malicious attacks, which often creates a major vulnerability in network security. In addition, since the radio access network has been softwareized now, but a result of the softwareization may lead to more vulnerabilities (base stations of the prior art all use same hardware specifications, it is less prone to vulnerabilities), which makes network attackers easier to attack the fifth generation core network through the N2 interface. In view of this, the disclosure provides an information security early warning device. The information security early warning device of the disclosure performs dynamic analysis on data flows through the N2 interface. Such dynamic analysis uses dynamic simulation of virtual machines to further update a malicious feature database and a normal flow whitelist. Therefore, the accuracy of malicious attack warnings will be greatly improved.

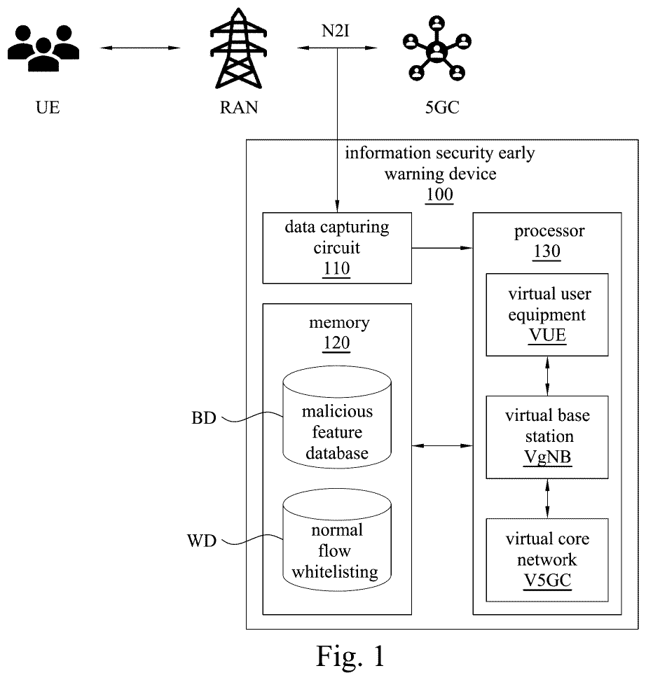

Referring to FIG. 1, FIG. 1 is a schematic diagram of the information security early warning device 100 of the present disclosure. As shown in FIG. 1, in a recent fifth generation mobile network architecture, a user equipment UE is connected to the radio access network RAN, and the radio access network RAN is connected to the fifth generation core network 5GC, where the N2 interface N2I exists between a next generation node B (gNB) (not shown) in the radio access network RAN and a access and mobility management function (AMF) (not shown) in the fifth generation core network 5GC. The information security early warning device 100 of the present disclosure captures a data flow from the N2 interface N2I.

In this embodiment, the information security early warning device 100 includes a data capturing circuit 110, a memory 120 and a processor 130. The processor 130 is connected to the data capturing circuit 110 and the memory 120.

In some embodiments, the data capturing circuit 110 can be implemented using a transmission circuit for capturing data flows from the N2 interface N2I. In some embodiments, the memory 120 can be implemented by using a memory cell, a flash memory, a read-only memory, a hard disk, or any equivalent storage device. In some embodiments, the processor 130 can be implemented by a processing unit, a central processing unit, or a computing unit.

The data capturing circuit 110 captures a data flow by mirroring (hereinafter, the captured data flow is referred to as a first data flow). In some embodiments, the data capturing circuit 110 can capture the first data flow in NetFlow format from the N2 interface N2I in a mirroring method. In other words, the data capturing circuit 110 can copy and capture the data flow transmitted through the N2 interface N2I.

The memory 120 stores a malicious feature database BD and multiple instructions. In some embodiments, the multiple instructions can be instructions implemented by firmware or software. In some embodiments, the malicious feature database BD can store multiple malicious features, where the malicious feature indicates a feature related to a data flow of the malicious attack. In some embodiments, the malicious features can include malicious procedure code sequences, malicious information elements, or a combination of both.

For example, the malicious procedure code sequence can include multiple procedure codes arranged in sequence, where these procedure codes in this order can cause the paralysis of the fifth generation core network 5GC. A malicious information element is a malicious field (e.g., a redundant field other than packet fields defined by a next generation application protocol (NGAP), or a missing field under the definition of the NGAP) in a packet of the data flow or a malicious value (e.g., a value in the specific field does not conform to the value of the specific field as defined by the NGAP) in a specific field, where the malicious field or the malicious value in the specific field will also cause the paralysis of the fifth generation core network 5GC.

In some embodiments, the memory 120 can further store a normal flow whitelisting WD, where the normal flow whitelisting WD can include multiple normal flow features. In some embodiments, the normal flow features can include normal procedure code sequences, normal information elements or a combination of both.

For example, the normal procedure code sequence can include multiple procedure codes arranged in sequence, wherein the multiple procedure codes arranged in this sequence will not cause the fifth generation core network 5GC to be paralyzed. The normal information elements are normal fields (e.g., packet fields defined by the NGAP) in a packet of the data flow and normal values in the fields (e.g., values of the fields defined by the NGAP), where the normal fields and the normal values will not cause the paralysis of the fifth generation core network 5GC.

In some embodiments, the processor 130 can run a machine learning model based on a corresponding software or firmware instruction program, and the machine learning model can be trained using the malicious feature database BD, and determine whether the data flow is a malicious flow. In addition, the processor 130 can also run another machine learning model based on the corresponding software or firmware instruction program, and the other machine learning model can be trained by using the normal flow whitelist WD, and determine whether the data flow is abnormal.

It should be noted that the above-mentioned updating of these databases will be described in detail in the following paragraphs.

The processor 130 runs the virtual user equipment VUE, the virtual base station VgNB and the virtual core network V5GC based on corresponding software or firmware instruction programs, and accesses the above-mentioned instructions. In some embodiments, the processor 130 can use a virtual machine to run the virtual user equipment VUE, the virtual base station VgNB, and the virtual core network V5GC. In some embodiments, the virtual user equipment VUE and the virtual base station VgNB can be run by a virtual machine, and the virtual core network V5GC can be run by another virtual machine (because the virtual core network V5GC has more complex functions and computing capabilities).

In some embodiments, the processor 130 can generate and execute the virtual machine according to the virtual machine specification and related information of the virtual disc image file pre-stored in the memory 120, where the virtual machine can use virtual hardware or software to execute a corresponding virtual operating system and corresponding virtual applications.

In some embodiments, the virtual user equipment VUE can be the user equipment UE, which is virtualized, described above, and the virtual user equipment VUE has the same functions and computing capabilities as the user equipment UE. In some embodiments, the virtual base station VgNB can be the gNB, which is virtualized, in the radio access network RAN described above, and the virtual base station VgNB has the same functions and computing capabilities as the gNB. In some embodiments, the virtual core network V5GC cab be the access and mobility management function, which is virtualized, in the fifth generation core network 5GC described above, and the virtual core network V5GC has the same functions and computing capabilities as the access and mobility management function.

It should be noted that the operations of the above-mentioned virtual user equipment VUE, virtual base station VgNB and virtual core network V5GC will be described in detail in the following paragraphs.

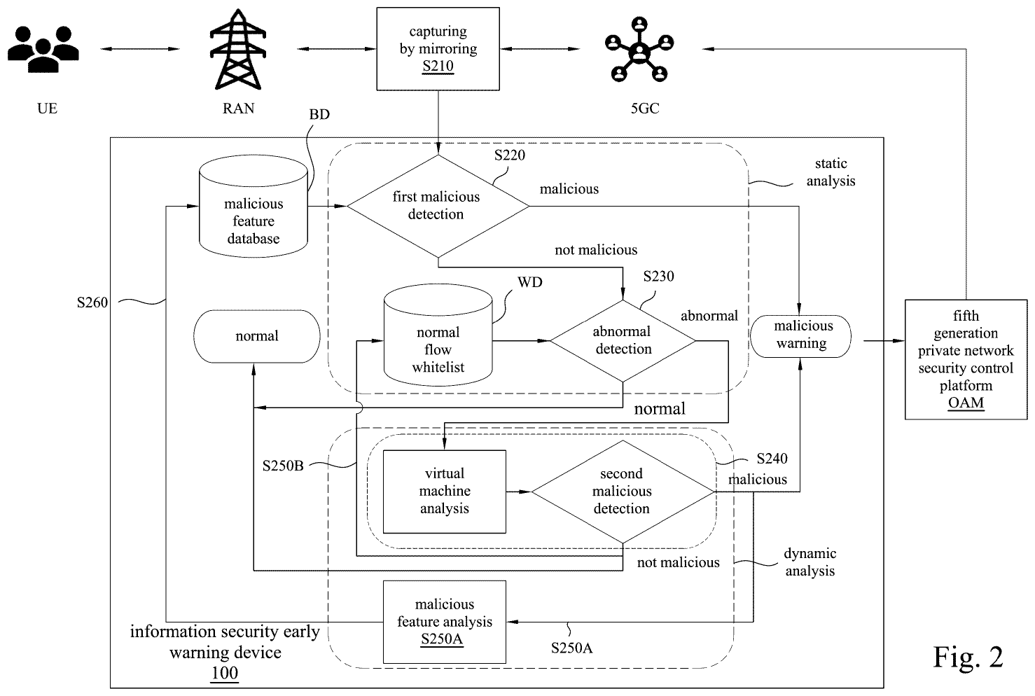

Referring to FIG. 2 together, FIG. 2 is a schematic diagram of implementing an information security early warning method according to some embodiments of the present disclosure. The method of the embodiment shown in FIG. 2 can be applied to the information security early warning device 100 in FIG. 1, and is described in conjunction with each element in the information security early warning device 100, but is not limited thereto. As shown in FIG. 2, the information security early warning method includes steps S210-S260.

First, in step S210, the data capturing circuit 110 captures the first data flow by mirroring. Next, a stage of static analysis is entered (i.e., steps S220 to S230). In some embodiments, the data capturing circuit 110 can capture the first data flow transmitted through the N2 interface N2I.

In step S220, the processor 130 detects (i.e., first malicious detection) the first data flow according to the malicious feature database BD. When the first data flow is not the malicious flow, enters step S230. On the contrary, a malicious warning message is generated, and the malicious warning message is transmitted to the generation private network security control platform OAM.

In some embodiments, the malicious warning message can indicate that a malicious attack has currently occurred on the N2 interface N2I. In some embodiments, the fifth generation private network security control platform OAM can be implemented by a network management host or a network management server for managing the network.

In step S230, the processor 130 performs anomaly detection on the first data flow. The anomaly detection is further described below.

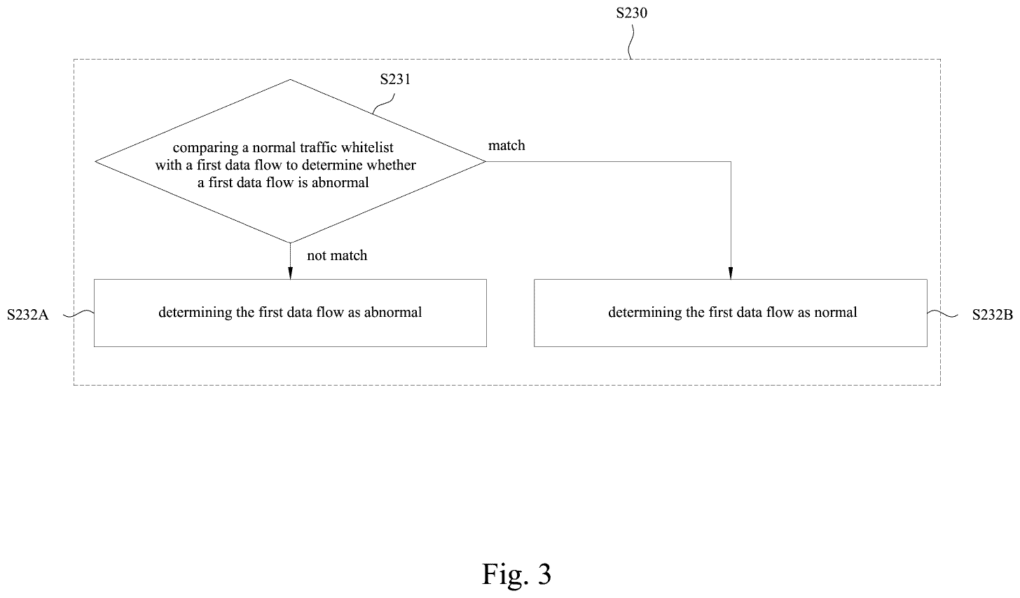

Referring also to FIG. 3, FIG. 3 is a flowchart of the detailed steps of step S230 in FIG. 2 according to some embodiments of the present disclosure. As shown in FIG. 3, step S230 includes steps S231 to S232B.

In step S231, the processor 130 compares the normal flow whitelist WD with the first data flow. When the first data flow does not match the normal flow whitelist, enters step S232A. On the contrary, enters step S232B. In step S232A, the processor 130 determines that the first data flow is abnormal. In step S232B, the processor 130 determines that the first data flow is normal.

As shown in FIG. 2, when the processor 130 determines that the first data flow is abnormal, enters a dynamic analysis stage (i.e., steps S240-S250B). When the processor 130 determines that the first data flow is normal, the processor 130 determines that the first data flow is a normal flow.

In step S240, the processor 130 simulates (i.e., virtual machine simulation) transmission of the first data stream from the virtual base station VgNB to the virtual core network V5GC, and determines whether a connection between the virtual user equipment VUE and the virtual core network V5GC can be established after the virtual core network V5GC receives the first data flow (i.e., second malicious detection). When the connection between the virtual user equipment VUE and the virtual core network V5GC cannot be established (i.e., determine to be malicious), enters step S250A, so as to generate a malicious warning message, and transmit the malicious warning message to the fifth generation private network security control platform OAM. On the contrary (i.e., determines to be not malicious), the processor 130 determines that the first data flow is the normal flow, and enters step S250B.

The simulating transmission and connection establishment are further described below.

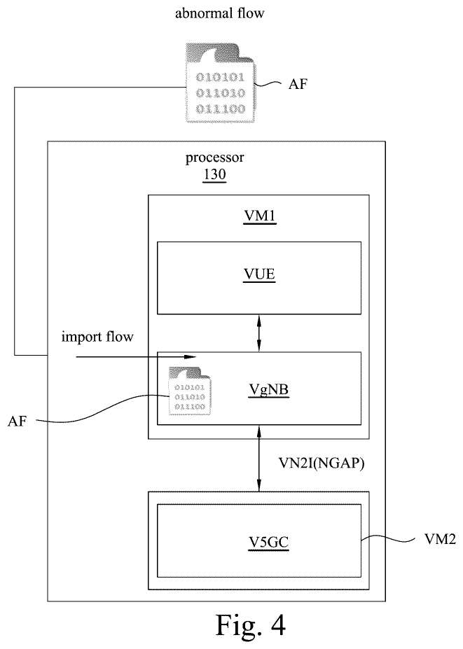

Referring also to FIG. 4, FIG. 4 is a schematic diagram of the simulating transmission according to some embodiments of the present disclosure. As shown in FIG. 4, the processor 130 performs virtual machines VM1-VM2. The virtual machine VM1 is used to simulate the virtual user equipment VUE and the virtual base station VgNB. The virtual machine VM2 is used to simulate the virtual core network V5GC. Through the processor 130, a virtual connection is established between the virtual base station VgNB, the virtual user equipment VUE and the virtual core network V5GC, where the processor 130 simulates a virtual N2 interface VN2I between the virtual user equipment VUE and the virtual core network V5GC, and the virtual N2 interface VN2I supports the NGAP.

Since most of the attacks on the fifth generation core network 5GC come from the radio access network RAN, the processor 130 imports the first data flow AF (i.e., an abnormal flow) that has been determined to be traffic into the virtual base station VgNB for transmission to the virtual core network V5GC.

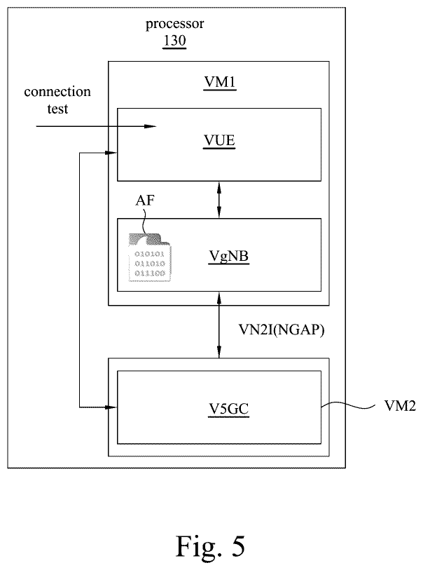

Referring also to FIG. 5, FIG. 5 is a schematic diagram of establishing the connection according to some embodiments of the present disclosure. As shown in FIG. 5, after the processor 130 imports the first data flow AF, which has been determined to be abnormal, into the virtual base station VgNB for transmission to the virtual core network V5GC, the processor 130 determines whether the connection between the virtual user equipment VUE and the virtual core network V5GC can be established after the virtual core network V5GC receives the first data flow AF (i.e., a connection test).

For example, the processor 130 can simulate the virtual user equipment VUE to transmit a connection request to the virtual core network V5GC through the virtual base station VgNB, and detect whether the virtual user equipment VUE receives a connection response. When receiving the connection response, the processor 130 determines that the connection between the virtual user equipment VUE and the virtual core network V5GC can be established.

As shown in FIG. 2, in step S250A, the processor 130 selects (i.e., malicious feature analysis) an error log from multiple detection logs generated by the virtual core network V5GC, where the error log indicates that a first error packet in the first data flow has a first malicious procedure code.

In some embodiments, when the connection between the virtual equipment VUE and the virtual core network V5GC cannot be established, the virtual core network V5GC can detect the first data flow uploaded by the virtual base station VgNB to generate the multiple detection logs, where each detection log corresponds to each packet in the first data flow.

In some embodiments, when the virtual base station VgNB detects that the detection log indicates that an error appears in the procedure code of the packet in the first data flow, the virtual base station VgNB can use the detection log as the error log, and regard the packet and the procedure code as the first error packet and the first malicious procedure code respectively, so as to capture the error packet.

For example, when the virtual base station VgNB needs to perform a specific procedure (e.g., the virtual user equipment VUE makes the connection request to the virtual core network V5GC) with the virtual core network V5GC, the virtual base station VgNB transmits the data flow corresponding to the specific procedure, where the procedure codes of the multiple packets in the data flow have specific values and a specific sequence. The virtual core network V5GC can identify the values and the sequence of the procedure codes of the multiple packets according to the specific procedure. When the virtual core network V5GC detects that a value or the corresponding sequence of the procedure code of a packet is wrong, the virtual core network V5GC can generate the error log, and the error log indicates that the error packet in the data flow has a malicious procedure code.

The following will describe the error log with an actual example.

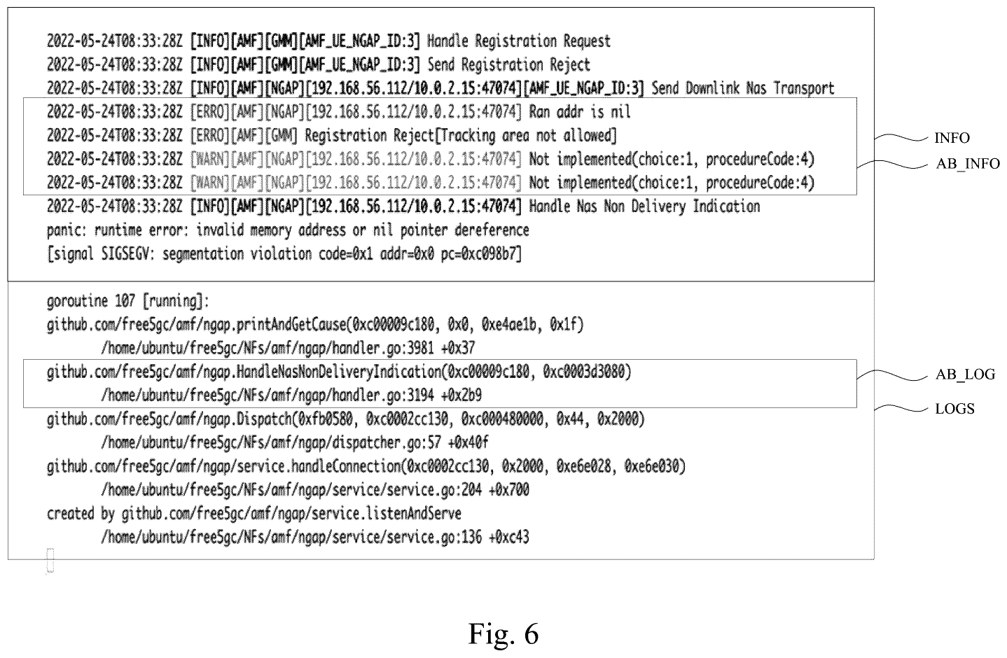

Referring also to FIG. 6, FIG. 6 is a schematic diagram of the detection log LOGS according to some embodiments of the present disclosure. As shown in FIG. 6, when the virtual base station VgNB needs to perform a specific procedure with the virtual core network V5GC, the virtual base station VgNB transmits the data flow corresponding to the specific procedure, and the virtual core network V5GC generates monitoring information according to the data flow. The virtual core network V5GC detects the specific procedure to be performed recently according to the data flow, and identifies the values and the sequence that the procedure codes of the multiple packets in the data flow should have according to the specific procedure, so as to generate monitoring information accordingly.

The monitoring information includes detection information INFO and detection logs LOGS, the detection information INFO indicates multiple detection results, and the detection logs LOGS indicate specific procedure information (e.g., “HandleNasNonDelivery”). The processor 130 can capture abnormal information AB_INFO (information indicating “ERROR” or “WARNING”) from the detection information INFO, and capture an error log AB_LOG corresponding to the abnormal information AB_INFO from the detection logs LOGS. The error log AB_LOG indicates an error procedure code information “HandleNasNonDelivery”, the error procedure code information “HandleNasNonDelivery” indicates a procedure code, and this procedure code is 35 (NGAP defines what procedure code corresponds to the procedure code information). In this way, the processor 130 selects the error log AB_LOG from the detection logs LOGS. In addition, the processor 130 can also select a packet with this procedure code from the first data flow, so as to obtain (e.g., confirm) that the packet has an error.

As shown in FIG. 2, in step S250B, the processor 130 updates a setting of the anomaly detection by using the first data flow. In some embodiments, the processor 130 can update the normal flow whitelist WD by using the first data flow. In some embodiments, the processor 130 can update the normal flow whitelist WD with a normal procedure code sequence corresponding to the first data flow.

For example, the first data flow has the normal procedure code sequence that can be generated from the procedure codes of 3 packets in the first data flow, where the normal procedure code sequence is 1→6→7. In other words, when the procedure codes of the 3 packets are 1, 6, and 7 in sequence, the fifth generation core network 5GC will not be paralyzed. Therefore, the normal procedure code sequence can be stored (i.e., the normal flow whitelist WD is updated) in the normal flow whitelist WD.

It should be noted that, since the present disclosure will update the normal flow whitelist WD in real time and dynamically, this will greatly reduce the possibility of the data flow being falsely reported as abnormal.

In step S260, the processor 130 updates the malicious feature database BD by using the first malicious procedure code and the first data flow.

In some embodiments, the processor 130 can generate a first malicious procedure code sequence from the procedure codes of multiple packets in the first data flow, and generate a malicious feature including the first malicious procedure code sequence and the first malicious procedure code, so as to store the malicious feature in the malicious feature database BD. For example, Table 1 below is a malicious feature.

TABLE 1

| malicious | Malicious procedure | malicious procedure | |
|---|---|---|---|
| feature number | code sequence | code | response |
| A | 15 −> 6 −> 7 | 15 | error |

It can be known from Table 1 that the malicious feature number of the above-mentioned malicious feature is A, the malicious procedure code sequence is 15, 6 and 7 in sequence, and the malicious procedure code is 15, and such malicious feature causes the fifth generation core network 5GC to be paralyzed (i.e., error). In other words, such the malicious feature indicates that when the procedure codes of the 3 packets are 15, 6, and 7 in sequence, the fifth generation core network 5GC will be paralyzed, and the procedure code 15 is mainly caused.

The present disclosure can not only update the malicious feature database BD with the malicious features that cause the paralysis of the fifth generation core network 5GC, but also expand the malicious features. The augmentation of the malicious features will be further described below.

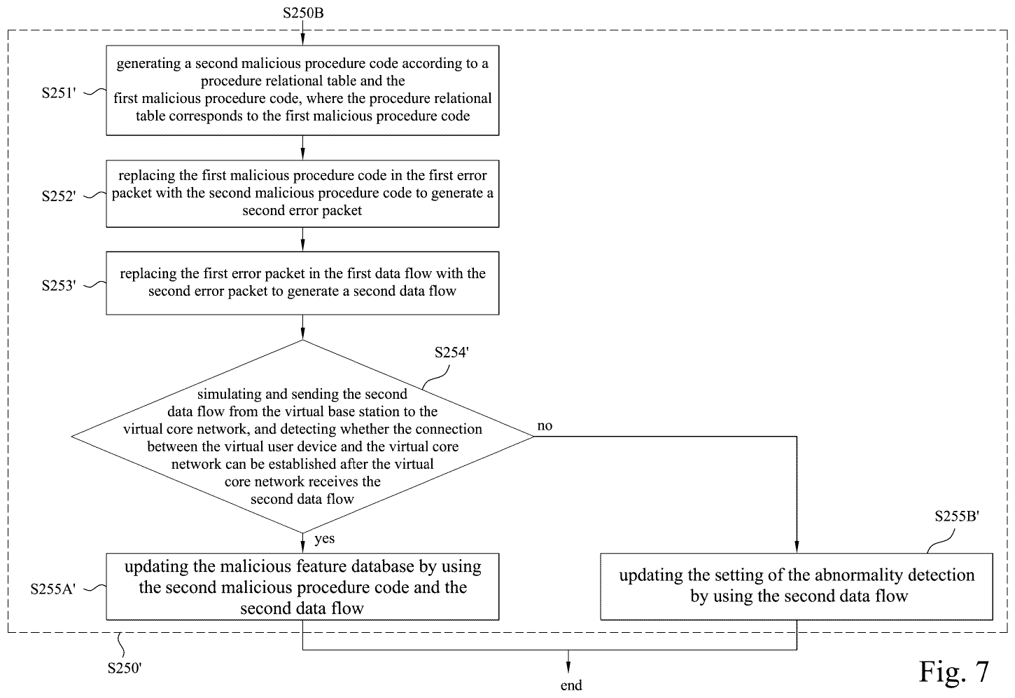

Referring also to FIG. 7, FIG. 7 is a flowchart of step S250′ further included in FIG. 2 according to some embodiments of the present disclosure. As shown in FIG. 7, step S250′ includes steps S251′ to S2556′.

When step S250B has been performed, enters step S251′. In step S251′, the processor 130 generates a second malicious procedure code according to a procedure relational table and the first malicious procedure code, where the procedure code relational table corresponds to the first malicious procedure code. In some embodiments, the procedure relational table includes multiple relational values between the first malicious procedure code and multiple candidate procedure codes (the NGAP defines which procedure code is most related to the procedure code). In some embodiments, the processor 130 selects the candidate procedure code with the highest relational value from the multiple f candidate procedure codes, and uses the candidate procedure code with the highest relational value as the second malicious procedure code.

For example, following Table 2 is the procedure relational table.

TABLE 2

| procedure code information | procedure code | relational value |
|---|---|---|
| DownLinkNASTransport | 4 | — |
| DownLinkNAS | 6 | 3 |
| Configuration Transport | | |
| DownLinkNAS Status | 7 | 3 |
| Transport | | |
| UPLinkNASTransport | 46 | 2 |
| Initial UE MEssage | 15 | 1 |

It can be known from Table 2 that this is the procedure relational table of the procedure code information “DownLinkNASTransport”. The procedure relational table indicates that the most related to the procedure code information “DownLinkNASTransport” are the procedure code information “DownLinkNAS Configuration Transport” and the procedure code information “DownLinkNAS Status Transport” (i.e., having the highest relational value of 3). Therefore, the procedure code 6 or 7 can be used as the second malicious procedure code.

In step S252′, the processor 130 replace the second malicious procedure code with the first malicious procedure code in the first error packet to generate a second error packet. In other words, the processor 130 uses the second malicious procedure code as the procedure code in the first error packet to replace the original first malicious procedure code, so as to generate the second error packet.

In step S253′, the processor 130 replaces the first error packet in the first data flow with the second error packet to generate a second data flow. In other words, the processor 130 replaces the first error packet in the first data flow with the second error packet.

For example, referring to Table 1, assuming that the first malicious procedure code sequence is 15→6→7, the first malicious procedure code is 15, and the procedure code 16 is most related to the first malicious procedure code 15, then the processor 130 can use the procedure code 16 as the second malicious procedure code, and modify the procedure code of the first error packet corresponding to the first malicious procedure code to 16 to generate the second error packet. In this way, the processor 130 can replace the first error packet in the first data flow with the second error packet to generate the second data flow. At this time, the processor 130 can generate a second malicious program code sequence from the second data stream, and the second malicious procedure code sequence of the second data flow is 16→6→7.

In step S254′, the processor 130 simulates transmission of the second data flow from the virtual base station VgNB to the virtual core network V5GC, and detects whether the connection between the virtual user equipment VUE and the virtual core network V5GC can be established after the virtual core network V5GC receives the second data flow. When the connection between the virtual user equipment VUE and the virtual core network V5GC can be established (i.e., determined to be not malicious), enters step S255A′. On the contrary (i.e., determined to be malicious), enters step S255B′.

It is should be noted that the simulating connection method for the second data flow is the same as the above-mentioned simulating connection method for the first data flow. Therefore, it will not be repeated here.

In step S255A′, the processor 130 updates the setting of the anomaly detection by using the second data flow. In step S255B′, the processor 130 updates (i.e., add features of unknown attacks) the malicious feature database BD by using the second malicious procedure code and the second data flow. Next, the information security warning method in the present disclosure is ended. It should be noted that, the method for updating the setting of anomaly detection and the method for updating the malicious feature database BD are respectively the same as the above-mentioned steps S2506 and S260. Therefore, it will not be repeated here.

The present disclosure can not only augment malicious features, but also augment malicious information elements in malicious features. The augmentation of malicious features will be further described below.

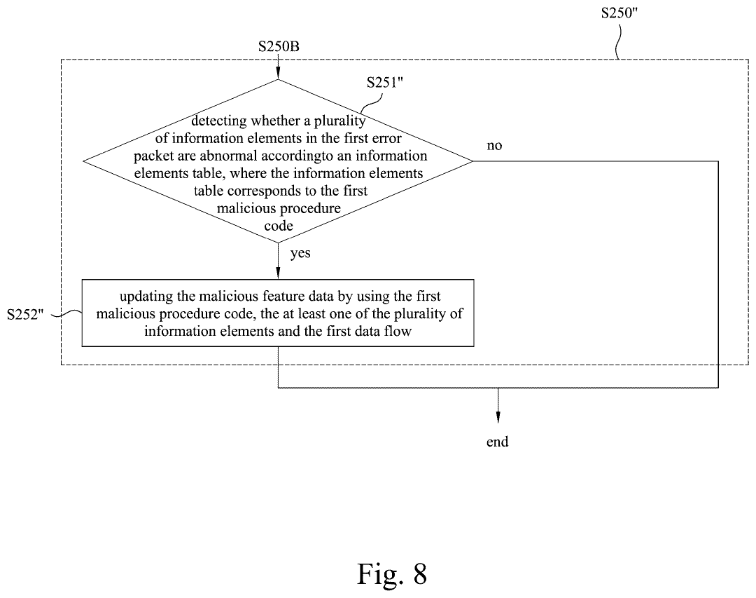

Referring also to FIG. 8, FIG. 8 is a flowchart of step S250″ further included in FIG. 2 according to some embodiments of the present disclosure. As shown in FIG. 8, step S250″ includes steps S251″-S252″.

When step S250B has been performed, enters step S251″. In step S251″, the processor 130 detects whether multiple information elements in the first error packet are abnormal according to an information elements table, where the information elements table corresponds to the first malicious procedure code. When at least one of the multiple information elements in the first error packet is abnormal, enters step S252″. On the contrary, the information security warning method in the present disclosure is ended.

In some embodiments, the information elements table indicates multiple necessary fields included in the packet corresponding to the first malicious procedure code and a value range corresponding to each required field (both are defined by the NGAP). In other words, different procedure codes will have different information elements tables.

In some embodiments, the processor 130 can compare multiple fields of the first error packet with the multiple necessary fields to determine whether redundant fields or missing fields in the first error packet exist, and compare the multiple fields in the first error packet with the multiple corresponding value ranges to determine whether the abnormal value in the field in the first error packet exists. Next, the processor 130 can regard the redundant field or the missing field as a malicious field, and use the abnormal value of the field as a malicious value.

In step S252″, the processor 130 updates the malicious feature database BD by using the first malicious procedure code, at least one of the multiple information elements and the first data flow.

In some embodiments, the processor 130 can generate the first malicious procedure code sequence according to the procedure codes of the first data flow, and generate the malicious field or the malicious value from at least one of the multiple information elements. Next, the processor 130 can generate a malicious feature, where the malicious feature includes the first malicious procedure code, the first malicious procedure code sequence, and the malicious field or malicious value. In this way, the processor 130 can update the malicious feature database BD by using the malicious feature.

In summary, the information security early warning device and method of the present disclosure use the method of simulating the 5G environment to dynamically determine whether the data flow of the N2 interface will cause the paralysis of the 5G core network, and update the malicious feature database and the normal flow whitelist according to the determining result. In this way, the determining accuracy of the malicious flow and abnormal flow will be greatly improved. In addition, the information security early warning device and method of the present disclosure further use the procedure code relational table and the information elements rule table to further expand malicious features to update the malicious feature database. In this way, the features of unknown attacks will be obtained to avoid unknown attacks that may occur in the future.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An information security early warning device, comprising:
a data capturing circuit, configured for capturing a first data flow by mirroring;
a memory, configured for storing a malicious feature database and a plurality of instructions;
a processor, connected to the data capturing circuit and the memory, configured for running a virtual user equipment, a virtual base station and a virtual core network, and accessing the plurality of instructions to perform following operations:
detecting the first data flow according to the malicious feature database, and when the first data flow is not a malicious flow, performing an anomaly detection on the first data flow;
when the first data flow is detected as abnormal, simulating transmission of the first data flow from the virtual base station to the virtual core network, and determining whether a connection between the virtual user equipment and the virtual core network can be established after the virtual core network receives the first data flow;
when the connection between the virtual user equipment and the virtual core network can be established, updating a setting of the anomaly detection by using the first data flow;
when the connection between the virtual user equipment and the virtual core network cannot be established, selecting an error log from a plurality of detection logs generated by the virtual core network, wherein the error log indicates that a first error packet in the first data flow has a first malicious procedure code; and
updating the malicious feature database by using the first malicious procedure code and the first data flow.

2. The information security early warning device of claim 1, wherein the processor further performs following operations:
comparing a normal flow whitelist with the first data flow to determine whether the first data flow is abnormal;
when the first data flow does not match the normal flow whitelist, determining that the first data flow is abnormal; and
when the connection between the virtual user equipment and the virtual core network can be established, updating the normal flow whitelist by using the first data flow.

3. The information security early warning device of claim 2, wherein the processor further performs following operations:
generating a second malicious procedure code according to a procedure relational table and the first malicious procedure code, wherein the procedure relational table corresponds to the first malicious procedure code;
replacing the first malicious procedure code in the first error packet with the second malicious procedure code to generate a second error packet;
replacing the first error packet in the first data flow with the second error packet to generate a second data flow;
simulating transmission of the second data flow from the virtual base station to the virtual core network, and detecting whether the connection between the virtual user equipment and the virtual core network can be established after the virtual core network receives the second data flow;
when the connection between the virtual user equipment and the virtual core network cannot be established, updating the malicious feature database by using the second malicious procedure code and the second data flow; and
when a connection between the virtual user equipment and the virtual core network can be established, updating the setting of the anomaly detection by using the second data flow.

4. The information security early warning device of claim 3, wherein the procedure relational table comprises a plurality of relational values between the first malicious procedure code and a plurality of candidate procedure codes, wherein the processor further performs following operations:
selecting a candidate procedure code with a highest relational value from the plurality of candidate procedure codes, and using the candidate procedure code with the highest relational value as the second malicious procedure code.

5. The information security early warning device of claim 1, wherein the processor further performs following operations:
detecting whether a plurality of information elements in the first error packet are abnormal according to an information elements table, wherein the information elements table corresponds to the first malicious procedure code; and
when detecting that at least one of the plurality of information elements in the first error packet is abnormal, updating the malicious feature database by using the first malicious procedure code, the at least one of the plurality of information elements and the first data flow.

6. The information security early warning device of claim 1, wherein the data capturing circuit is further configured for copying and capturing the first data flow transmitted through from a N2 interface by mirroring.

7. The information security early warning device of claim 1, wherein the processor further configured for running a first virtual machine and a second virtual machine, wherein the first virtual machine performs the virtual user equipment and the virtual base station, and the second virtual machine performs the virtual core network.

8. The information security early warning device of claim 1, wherein the processor further performs following operations:
when the connection between the virtual user equipment and the virtual core network cannot be established, detecting, by the virtual core network, the first data flow uploaded by the virtual base station to generate the plurality of detection logs, wherein each of the plurality of detection logs corresponds to each of a plurality of packet in the first data flow.

9. The information security early warning device of claim 1, wherein the processor further performs following operations:
when the connection between the virtual user equipment and the virtual core network cannot be established, generating a first malicious procedure code sequence from a plurality of procedure codes of a plurality of packets in the first data flow, and generating a malicious feature including the first malicious procedure code sequence and the first malicious procedure code, so as to store the malicious feature in the malicious feature database.

10. The information security early warning device of claim 1, wherein the malicious feature database stores a plurality of malicious features, where each of the plurality of malicious features indicates a feature related to a data flow of a malicious attack, wherein the plurality of malicious features comprises a plurality of malicious procedure code sequences, a plurality of malicious information elements, or a combination of both.

11. An information security early warning method, comprising:
capturing a first data flow by mirroring;
detecting the first data flow according to a malicious feature database, and when the first data flow is not a malicious flow, performing an anomaly detection on the first data flow;
when the first data flow is detected as abnormal, simulating transmission of the first data flow from a virtual base station to a virtual core network, and determining whether a connection between a virtual user equipment and the virtual core network can be established after the virtual core network receives the first data flow;
when the connection between the virtual user equipment and the virtual core network can be established, updating a setting of the anomaly detection by using the first data flow;
when the connection between the virtual user equipment and the virtual core network cannot be established, selecting an error log from a plurality of detection logs generated by the virtual core network, wherein the error log indicates that a first error packet in the first data flow has a first malicious procedure code; and
updating the malicious feature database by using the first malicious procedure code and the first data flow.

12. The information security early warning method of claim 11, further comprising:
comparing a normal flow whitelist with the first data flow to determine whether the first data flow is abnormal;
when the first data flow does not match the normal flow whitelist, determining that the first data flow is abnormal; and
when the connection between the virtual user equipment and the virtual core network can be established, updating the normal flow whitelist by using the first data flow.

13. The information security early warning method of claim 12, further comprising:
generating a second malicious procedure code according to a procedure relational table and the first malicious procedure code, wherein the procedure relational table corresponds to the first malicious procedure code;
replacing the first malicious procedure code in the first error packet with the second malicious procedure code to generate a second error packet;
replacing the first error packet in the first data flow with the second error packet to generate a second data flow;
simulating transmission of the second data flow from the virtual base station to the virtual core network, and detecting whether the connection between the virtual user equipment and the virtual core network can be established after the virtual core network receives the second data flow;
when the connection between the virtual user equipment and the virtual core network cannot be established, updating the malicious feature database by using the second malicious procedure code and the second data flow; and
when a connection between the virtual user equipment and the virtual core network can be established, updating the setting of the anomaly detection by using the second data flow.

14. The information security early warning method of claim 13, wherein the procedure relational table comprises a plurality of relational values between the first malicious procedure code and a plurality of candidate procedure codes, wherein the step of generating the second malicious procedure code according to the procedure relational table and the first malicious procedure code comprises:
selecting a candidate procedure code with a highest relational value from the plurality of candidate procedure codes, and using the candidate procedure code with the highest relational value as the second malicious procedure code.

15. The information security early warning method of claim 11, further comprising
detecting whether a plurality of information elements in the first error packet are abnormal according to an information elements table, wherein the information elements table corresponds to the first malicious procedure code; and
when detecting that at least one of the plurality of information elements in the first error packet is abnormal, updating the malicious feature database by using the first malicious procedure code, the at least one of the plurality of information elements and the first data flow.

16. The information security early warning method of claim 11, further comprising:
copying and capturing the first data flow transmitted through from a N2 interface by mirroring.

17. The information security early warning method of claim 11, further comprising:
running a first virtual machine and a second virtual machine, wherein the first virtual machine performs the virtual user equipment and the virtual base station, and the second virtual machine performs the virtual core network.

18. The information security early warning method of claim 11, further comprising:
when the connection between the virtual user equipment and the virtual core network cannot be established, detecting, by the virtual core network, the first data flow uploaded by the virtual base station to generate the plurality of detection logs, wherein each of the plurality of detection logs corresponds to each of a plurality of packet in the first data flow.

19. The information security early warning method of claim 11, further comprising:
when the connection between the virtual user equipment and the virtual core network cannot be established, generating a first malicious procedure code sequence from a plurality of procedure codes of a plurality of packets in the first data flow, and generating a malicious feature including the first malicious procedure code sequence and the first malicious procedure code, so as to store the malicious feature in the malicious feature database.

20. The information security early warning method of claim 11, wherein the malicious feature database stores a plurality of malicious features, where each of the plurality of malicious features indicates a feature related to a data flow of a malicious attack, wherein the plurality of malicious features comprises a plurality of malicious procedure code sequences, a plurality of malicious information elements, or a combination of both.
